(19) United States
(12) Patent Application Publication
(10) Pub. No.: US 2012/0133753 A1
(43) Pub. Date: May 31, 2012

(54) SYSTEM, DEVICE, METHOD, AND COMPUTER PROGRAM PRODUCT FOR FACIAL DEFECT ANALYSIS USING ANGULAR FACIAL IMAGE

(76) Inventors: Chuan-Yu Chang, Tainan County (TW); Pao-Choo Chung, Tainan City (TW); Shung-Cheng Li, Changhua County (TW); Jia-Sin Li, Changhua County (TW); Jui-Yi Kuo, Tainan City (TW); Heng-Yi Liao, Douliu City (TW)

(21) Appl. No.: 12/971,858

(22) Filed: Dec. 17, 2010

(30) Foreign Application Priority Data
Nov. 26, 2010 (TW) 099141006

(51) Int. Cl. H04N 7/18; G06K 9/46

(52) U.S. Cl. 348/77; 382/190; 348/E07.085

(57) ABSTRACT

A system, device, method, and computer program product for facial defect analysis using an angular facial image are provided. The system includes a storage module, an image angle detection module, a feature definition module, and a skin analysis module. The storage module stores at least one angular facial image, at least one skin defect condition, and at least one of multi-angle facial feature conditions. The image angle detection module detects an angle of the angular facial image. The feature definition module analyzes the angular facial image according to the facial feature conditions, so as to obtain at least one facial skin area image. The skin analysis module determines whether at least one skin defect image exists in the at least one facial skin area image by using the skin defect condition, and if yes, marks the at least one skin defect image in the at least one facial skin area image.

### BACKGROUND OF THE INVENTION

1. Cross-Reference to Related Application

This application claims the benefit of Taiwan Patent Application No. 099141006, filed on Nov. 26, 2010, which is hereby incorporated by reference for all purposes as if fully set forth herein.

2. Field of Invention

The present invention relates to a system, method, and computer program product for facial defect analysis using an angular facial image, and more particularly to a facial defect analysis system, method, and computer program product applicable to a long distance cosmetic medical care system and capable of obtaining by analysis facial skin defects and positions thereof by using an angular facial image shot by a common video camera.

3. Related Art

In the prior art, a patient goes to a medical cosmetic institution for facial cosmetology, and is assisted in treating his/her facial skin by a professional doctor. In the medical care, the doctor first shoots the face of the patient with a shooting device such as a camera or a video camera, so as to obtain pictures or images of different parts of the face of the patient, and selects from them the pictures or images presenting skin defect images like wrinkles, spots, and acne scars. For physical pictures, the parts presenting the skin defect images on the physical pictures can be circled with any color pens; while for digital images, the parts presenting the skin defect images are circled on a display screen of an operation interface with a light pen or directly circled on the display screen by using a relevant marking function of the operation interface. Afterwards, the doctor and the patient together evaluate and discuss about the parts requiring skin cosmetology and treatment.

However, the above operating mode consumes a lot of time and efforts for both sides, including the manual operation and time of the doctor for determining the skin defect parts, and even the manual operation and time of the doctor for making medical process suggestions and postoperative predictions and evaluations as well as creating predicted resulting images for the patient. Therefore, doctors and patients gradually utilize a long distance healthcare for communication and evaluation. For example, a patient can shoot a facial picture/image by himself/herself and transfer the picture/image to a doctor, and the doctor can give evaluation after viewing the facial picture/image of the patient, so as to accelerate the determination and treatment processes of the facial cosmetic medical care, thus reducing the burden of the doctor and the patient.

Moreover, in the prior art, a facial defect analysis system is also provided, which can analyze a facial picture/image automatically to find and mark defects such as wrinkles, spots, and acne scars in the facial picture/image, so that a doctor can make determination and give suggestions rapidly. Furthermore, the doctor can also input the suggested cosmetic medical care modes, and the facial defect analysis system simulates a facial condition of the patient after the cosmetic medical care, such that the patient evaluates whether to accept the suggestions of the doctor and go through the cosmetic medical care.

However, in the conventional facial defect analysis system, a facial feature database has to be established in advance, and the facial picture/image uploaded by the patient is then compared. As in the prior art, a front-face picture (that is, the vertical or horizontal inclination of the face does not exceed 15 degrees) is mostly used for analysis, so as to obtain clear facial features, for example, complete shapes of five sense organs such as eyebrows, eyes, a nose, a lip, and a face shape or feature points. However, generally, when a patient shoots a facial picture, a picture/image satisfying front-face conditions usually fails to be shot, or facial defects of the patient can only be clearly shot when the face is rotated to a certain angle. In the conventional facial defect analysis system, for an angular facial picture/image, facial features thereof usually fail to be recognized, resulting in determination failures, and facial defect analysis failures, and causing a lot of problems. For example, the facial picture/image provided by the patient has many restrictions, and when an angle exists in the facial picture/image, the analysis result becomes quite inaccurate and the analysis even cannot be performed.

### SUMMARY OF THE INVENTION

In order to solve the problem in the prior art that angular facial picture/images are unable to be recognized or analyzed in the facial defect analysis technology, the present invention is directed to an analysis system for facial defect analysis using an angular facial image and a method thereof.

The present invention provides a system for facial defect analysis using an angular facial image, which comprises: an image angle detection module, electrically coupled to a storage module, and used for detecting an angle of the angular facial image; a feature definition module, electrically coupled to the storage module and the image angle detection module, and used for analyzing the angular facial image according to the facial feature conditions, so as to obtain at least one facial skin area image; and a skin analysis module, electrically coupled to the storage module and the feature definition module, and used for determining whether at least one skin defect image exists in at least one facial skin area image by using at least one skin defect condition, and if yes, marking the at least one skin defect image in the at least one facial skin area image.

The present invention provides a method for facial defect analysis using an angular facial image for solving the above problem, which is applicable to an electronic apparatus. The electronic apparatus at least comprises a storage module for storing at least one skin defect condition and at least one of a plurality of multi-angle facial feature conditions.

The method comprises: obtaining an angular facial image; detecting an angle of the angular facial image; analyzing the angular facial image according to the identified angle and at least one of the plurality of multi-angle facial feature conditions, so as to obtain at least one facial skin area image; analyzing at least one facial skin area image by using the at least one skin defect condition; determining whether at least one skin defect image exists; and when the at least one skin defect image exists, marking the at least one skin defect image in the at least one facial skin area image.

The present invention further provides a device for facial defect analysis using an angular facial image, which comprises: a case; an image capturing unit, disposed outside the case, and used for shooting a face of a user to form an angular facial image; a display unit, disposed outside the case; a storage unit, disposed inside the case, electrically coupled to the image capturing unit, and used for storing the angular facial image, at least one skin defect condition, and at least one of a plurality of multi-angle facial feature conditions; and a processing unit, disposed inside the case, electrically coupled to the image capturing unit, the storage unit, and the display unit, and used for analyzing the angular facial image according to the facial feature conditions, so as to obtain at least one facial skin area image, determining whether at least one skin defect image exists in the at least one facial skin area image by using at least one skin defect condition, when the at least one skin defect image exists, marking the at least one skin defect image in the at least one facial skin area image, and displaying the angular facial image and the mark on the display unit.

The present invention further provides a computer program product, for being read by an electronic apparatus to perform the facial skin defect resolution method, and the process of the method is illustrated above, and will not be described herein again.

The present invention is characterized in that, at least one skin defect condition and a plurality of multi-angle facial feature conditions are pre-stored, so as to rapidly obtain a relevant facial skin area image by using the multi-angle facial feature conditions, and perform the skin defect determination operation by analyzing an angle of the angular facial image. Also, in the present invention, as the skin defect conditions are utilized, not only it can be determined automatically whether a skin defect image exists in the facial skin area image, but also a type of a skin defect displayed in the skin defect image can be further determined, so as to facilitate the doctor to perform the skin defect determination operation, and greatly reduce the operation time for determining the type of the skin defect. In addition, the present invention can provide more accurate skin defect information, which facilitates a doctor or expert system to provide appropriate cosmetic medical process suggestions and postoperative predictions and evaluations for the patient. Furthermore, in the present invention, a predicted resulting image after the cosmetic medical care can be generated in combination with relevant graphics software. In this manner, the time and efforts required from both sides of the doctor and the patient are effectively reduced.

### BRIEF DESCRIPTION OF THE DRAWINGS

The present invention will become more fully understood from the detailed description given herein below for illustration only, and thus are not limitative of the present invention, and wherein:

FIG. 1 is a schematic architectural view of a system for facial defect analysis using an angular facial image according to an embodiment of the present invention;

FIG. 2 is a schematic block diagram of the system for facial defect analysis using an angular facial image according to the embodiment of the present invention;

FIG. 3A is a flow chart of a method for facial defect analysis using an angular facial image according to an embodiment of the present invention;

FIG. 3B is a flow chart of a method for facial defect analysis using an angular facial image according to another embodiment of the present invention;

FIG. 4 is a schematic view of face inspection blocks according to an embodiment of the present invention;

FIG. 5 is a schematic view of facial feature determination according to an embodiment of the present invention;

FIG. 6A is a schematic view of a wrinkle image according to an embodiment of the present invention;

FIG. 6B is a schematic view of a wrinkle mark image according to an embodiment of the present invention;

FIG. 7A is a schematic view of a spot image according to an embodiment of the present invention;

FIG. 7B is a schematic view of a spot mark image according to an embodiment of the present invention; and

FIG. 8 is a schematic view of a device for facial defect analysis using an angular facial image according to an embodiment of the present invention.

### DETAILED DESCRIPTION OF THE INVENTION

In order to make the features and advantages of the present invention more comprehensive, the embodiments are illustrated in detail below with reference to the accompanying drawings. The angular facial image below refers to a digital picture or digital image shot by a digital camera, a digital video camera, or a video recorder in which a face has a deflection angle relative to a photographic lens, or part of video data captured from a video stream.

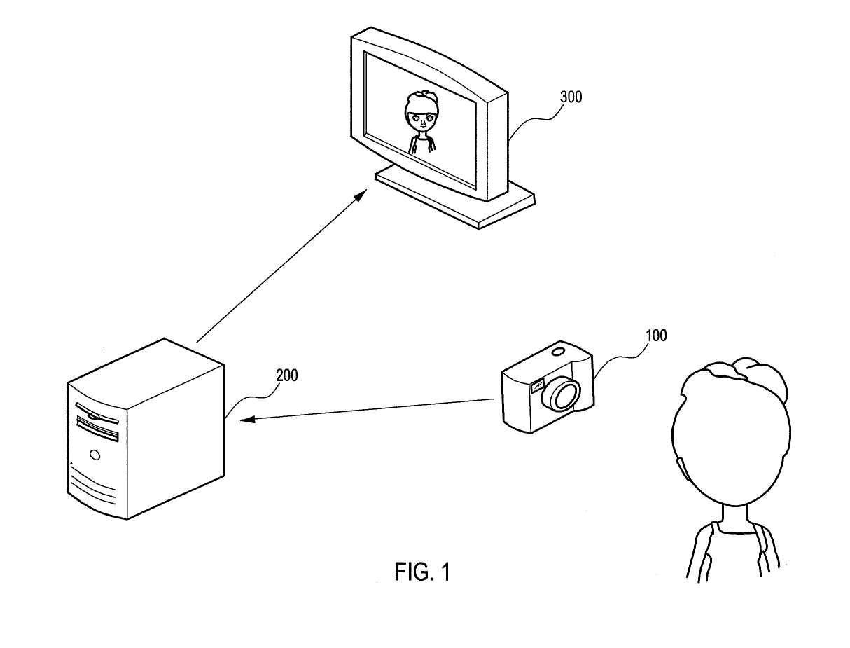

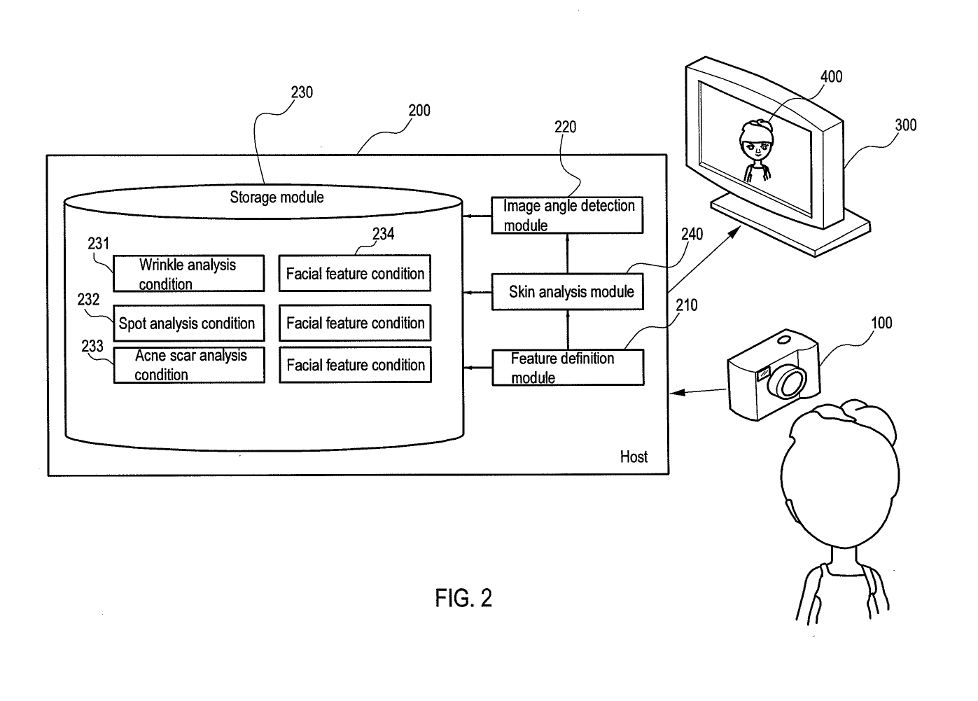

First, referring to FIG. 1 and FIG. 2 at the same time, FIG. 1 is a schematic architectural view of a system for facial defect analysis using an angular facial image according to an embodiment of the present invention, and FIG. 2 is a schematic block diagram of the system for facial defect analysis using an angular facial image according to the embodiment of the present invention. The system in this embodiment is applicable to an electronic apparatus, which is illustrated by, but not limited to, a host 200 in this embodiment. In other embodiments, the electronic apparatus can also be a personal computer, a notebook computer, a netbook, a tablet computer, a Kiosk, a personal digital assistant (PDA), or a smart phone. In other embodiments, the system according to the present invention can also be respectively disposed on a plurality of electronic apparatuses, which are connected in an electrical coupling mode. The system for facial defect analysis using an angular facial image in this embodiment mainly includes a host 200, and the host 200 includes a storage module 230, a feature definition module 210, an image angle detection module 220, and a skin analysis module 240. In addition, the host 200 may be further electrically coupled to a display module 300, each image or pattern including an angular facial image and a mark is displayed on the display module 300, and the display module 300 can be a monitor, a screen or a television screen.

In other embodiments, the system for facial defect analysis using an angular facial image can also include an image acquisition module 100 used for shooting a face of a user to form at least one angular facial image 400, which is illustrated by the angular facial image 400 in this embodiment. A horizontal deflection angle of the facial image can be in a range between negative 90 degrees and positive 90 degrees. The image acquisition module 100 is, but not limited to, a digital camera or a digital video camera, as long as it is a shooting device capable of forming a digital image after shooting a scene.

The storage module 230 is used for storing at least one skin defect condition and at least one of a plurality of multi-angle facial feature conditions 234. The storage module 230 can be electrically coupled to the image acquisition module 100, for example, the coupling and data transmission are achieved through an RS232 communication interface or in various wireless/wired communication modes, so as to obtain and store the angular facial image transferred from the image acquisition module 100, or the storage module 230 can obtain the angular facial image transferred from a remote computer or electronic device through other storage media/network connections. In this embodiment, a skin defect is, for example, a wrinkle furrow, a spot, and an acne scar, so that the skin defect condition includes a wrinkle analysis condition 231, a spot analysis condition 232, and an acne scar analysis condition 233 for illustration, but the present invention is not limited thereto, and other relevant skin defect cases are also applicable. In this embodiment, the multi-angle facial feature conditions include feature data of eyes, eyebrows, a nose, and a lip respectively corresponding to multiple angles, which will be illustrated after.

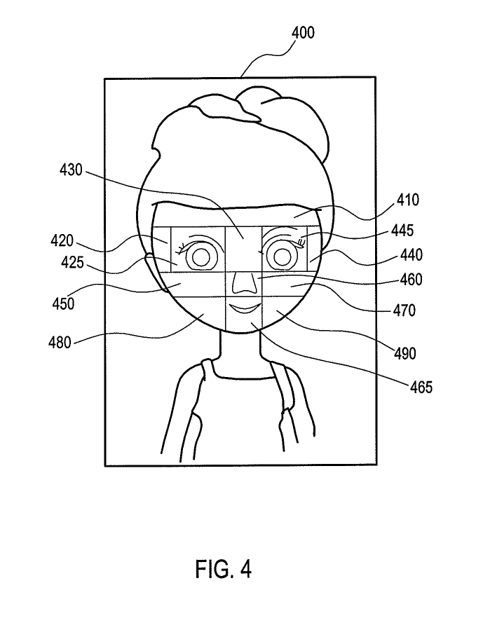

Referring to FIG. 4 at the same time, FIG. 4 is a schematic view of face range detection of an angular facial image according to the present invention. The image angle detection module 220 is electrically coupled to the storage module 230 and is able to detect an angle of the angular facial image 400, for example, a horizontal deflection angle and a vertical deflection angle of the face relative to the photographic lens. The image angle detection module 220 can be implemented as in the prior art. For example, first, through 2D face angle detection and feature point extracting, multiple 2D face multi-angle pictures are used to establish a multi-view face classifier. When the angle of the angular facial image 400 needs to be determined, according to the multi-view face classifier and the extracting of the face feature points of the angular facial image 400, the angle of the angular facial image 400 can be determined.

The feature definition module 210 is used for analyzing the angular facial image according to the facial feature conditions, so as to obtain at least one facial skin area image. For example, a face range in the angular facial image 400 is first found by using the conventional face detection technology, and images irrelevant to the face of the user are removed, so only the image of the face range is kept, that is, the facial skin area image. In the conventional face detection technology, for example, multiple faces are first collected, and a stable face model is obtained by training, an input facial image is searched and compared through the face model, and if the input facial image has an area conforming to the face model, it represents that the image contains a face, otherwise, the image contains no face. Alternatively, a basic algorithm for a specific 2D and 3D face detection/recognition technology is utilized for calculation and determination.

In other embodiments, the feature definition module 210 can further divide the facial skin area image into a plurality of inspection blocks according to the identified angle detected by the image angle detection module 220. As shown in FIG. 4, the inspection blocks can include a forehead block 410, a right canthus block 420, a right eye block 425, a nose bridge block 430, a left canthus block 440, a left eye block 445, a right cheekbone block 450, a nose tip block 460, a lip block 465, a left cheekbone block 470, a right cheek block 480, and a left cheek block 490.

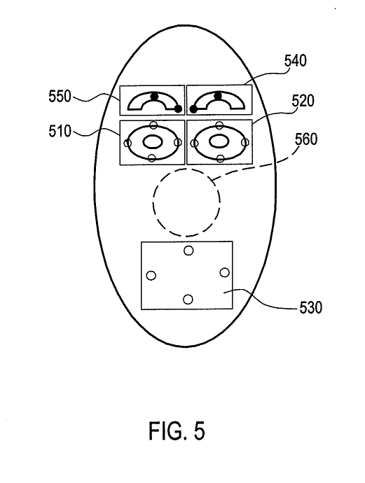

Referring to FIG. 5 at the same time, FIG. 5 is a schematic view of dividing the facial skin area image into a plurality of inspection blocks according to an embodiment of the present invention. In this embodiment, patterns of multiple angles and multiple parts of the face are used as a plurality of multi-angle facial feature conditions, such as a lip pattern, a left eye pattern, a right eye pattern, a left eyebrow pattern, a right eyebrow pattern, and a nose pattern, which are stored in the storage module 230. The feature definition module 210 can analyze the facial skin area image found from the angular facial image 400 by using the facial feature conditions 234 stored in the storage module 230, and find whether images conforming to the facial feature conditions 234 exist in the facial skin area image which are used as patterns in the facial skin area image, for example, whether a shape similar to an eye exists at a position corresponding to the eye in the facial skin area image, whether a shape similar to an eyebrow exists at a position corresponding to the eyebrow in the facial skin area image, and whether a shape similar to a lip exists at a position corresponding to the lip in the facial skin area image. Generally speaking, first, a plurality of sub area images can be obtained from the facial skin area image according to common positions of five sense organs on a face, in which each sub area image preferably includes a complete shape of each of the five sense organs, and a position thereof in the facial skin area image corresponds to a position of each of the five sense organs, for example, a sub area image in the lower middle part corresponds to the lip, and it then can be determined whether the sub area image has a shape similar to the lip. Next, the feature definition module 210 deduces positions of a lip pattern 510, a left eye pattern 520, a right eye pattern 530, a left eyebrow pattern 540, a right eyebrow pattern 550, and a nose pattern 560 in the facial skin area image by utilizing the conforming lip pattern 510, left eye pattern 520, right eye pattern 530, left eyebrow pattern 540, right eyebrow pattern 550, and nose pattern 560 found in the facial skin area image, and then divides the facial skin area image into a plurality of inspection blocks according to the positions of the patterns. This is exemplary, and the present invention is not limited thereto. Finally, the feature definition module 210 regards an image of each skin area as a facial skin area image, and each inspection block can be the right eye block 425, the left eye block 445, and the lip block 465 including patterns of a lip, an eye, and an eyebrow, or the forehead block 410, the right canthus block 420, the nose bridge block 430, the left canthus block 440, the right cheekbone block 450, the nose tip block 460, the left cheekbone block 470, the right cheek block 480, and the left cheek block 490 not including patterns of a lip, an eye, and an eyebrow. In this embodiment, the forehead block 410, the right canthus block 420, the nose bridge block 430, the left canthus block 440, the right cheekbone block 450, the nose tip block 460, the left cheekbone block 470, the right cheek block 480, and the left cheek block 490 are formed.

The skin analysis module 240 analyzes the facial skin area image by using the skin defect condition pre-stored in the storage module 230, so as to determine whether at least one skin defect image exists in the facial skin area image. The skin defect condition in this embodiment includes at least one of a wrinkle analysis condition, a spot analysis condition, and an acne scar analysis condition. In other embodiments, for the skin defect conditions pre-stored in the storage module 230, skin defect conditions corresponding to different inspection blocks can be further stored, for example, the left canthus block 440 and the right canthus block 420 correspond to the wrinkle analysis condition, the left cheek block 490 and the right cheek block 480 correspond to the spot analysis condition and the acne scar analysis condition, and part of detection areas such as the lip block 465 might have no corresponding skin defect condition, but the present invention is not limited thereto. Furthermore, the skin analysis module 240 can perform defect analysis on different inspection blocks respectively according to the skin defect conditions corresponding to the inspection blocks.

In other embodiments, the storage module 230 is further used for storing at least one suggestion data corresponding to a relevant skin defect condition, and the system according to the present invention can be further provided with a suggestion module (not shown in FIG. 2), which is used for automatically generating the corresponding suggestion data according to the marked skin defect image, a type of the skin defect image, a type of the mark, and the skin defect condition used for determining the skin defect image.

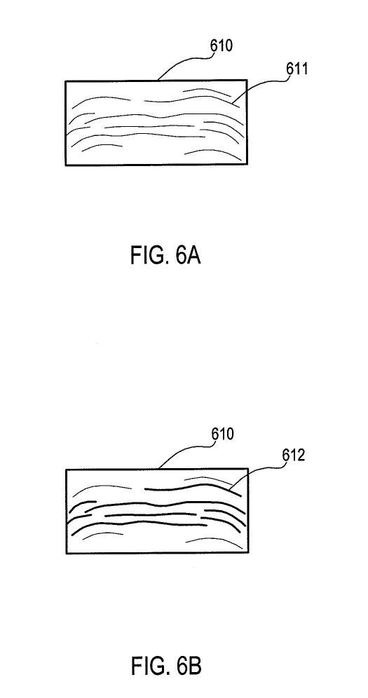

FIG. 6A is a schematic view of a wrinkle image according to the present invention, and FIG. 6B is a schematic view of a wrinkle mark image according to the present invention. If the skin defect condition includes the wrinkle analysis condition, the skin analysis module 240 analyzes each pixel in each facial skin area image and determines whether a plurality of dark pixels exists and the dark pixels form at least one continuous line. Furthermore, through a Gabor wavelet transform method, the skin analysis module 240 strengthens pixels of wrinkles in the image, removes noises, and thins the wrinkles, so as to determine that at least one continuous line is at least one wrinkle furrow. Taking the forehead block 410 for illustration, when determining that the continuous line exists in a forehead skin area image 610, the skin analysis module 240 determines that the continuous line is a wrinkle furrow 611, and puts a wrinkle furrow mark 612 on the wrinkle furrow 611, in which the marking mode can be to depict the detected wrinkle furrow by a simulated line.

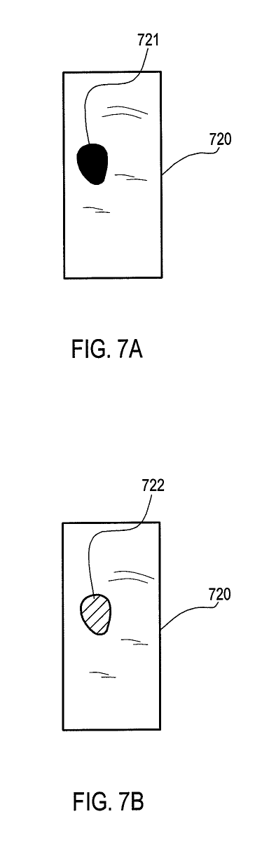

FIG. 7A is a schematic view of a spot image according to the present invention, and FIG. 7B is a schematic view of a spot mark image according to the present invention. If the skin defect condition includes the spot analysis condition, the skin analysis module 240 analyzes each pixel of each facial skin area image, and determines whether a plurality of dark pixels exists and the dark pixels form at least one dark block. Taking a left cheek skin area image 720 for illustration, when determining that the dark block exists, the skin analysis module 240 determines that the dark block is a spot pattern 721, and puts a pattern mark 722 conforming to the spot shape on the spot pattern 721.

It should be noted herein that, the dark pixel presents a skin luster deeper than that of the normal skin color, and has a degree of luster higher than an adaptive threshold. Such an adaptive threshold can be a system default value or preset by an operator via a human-machine interface of the system.

Furthermore, the skin analysis module 240 can further adjust a brightness of the facial skin area image or each inspection block so that the skin color presented by the facial skin area image or the inspection block conforms to a skin sample image, thereby preventing errors from occurring during analysis by the skin analysis module 240 due to different video cameras being used and the influence of the optical brightness of the shooting environment.

Similarly, the skin analysis module 240 analyzes each pixel of each facial skin area image, and determines whether a plurality of abnormal pixel data exists and the abnormal pixel data form at least one scar block. When determining that the scar block exists, the skin analysis module 240 introduces the scar block into an acne scar determination rule, so as to determine whether the scar block is an acne scar pattern, and if yes, puts a mark on the acne scar pattern on the facial skin area image.

It should be noted herein that, the abnormal pixel data includes color data different from that included in normal pixel data, that is, the abnormal pixel data presents a skin luster different from that of the normal skin color.

In addition, the acne scar has no particular shape and luster. In order to improve the accuracy of the acne scar determination rule, the acne scar determination rule may be established by a plurality of acne scar pattern samples in combination with a neural network. During the establishment, various different acne scar features are first extracted from various acne scar pattern samples, and then introduced into the neural network. Detection and calculation are performed on the different acne scar features by using self-learning, inductive inference, parallel computation, and other characteristics of the neural network, so as to generate an acne scar determination network corresponding to the acne scar features, and the acne scar determination network is regarded as the acne scar determination rule. The skin analysis module 240 determines whether the scar block is the acne scar pattern upon introducing the scar block into the acne scar determination network.

If the skin analysis module 240 determines that none of the facial skin area images and inspection blocks has the pattern satisfying the skin defect condition, the skin analysis module 240 does not put any mark on the facial skin area images and determines that the facial skin of the user corresponding to the facial skin area images has no skin defect.

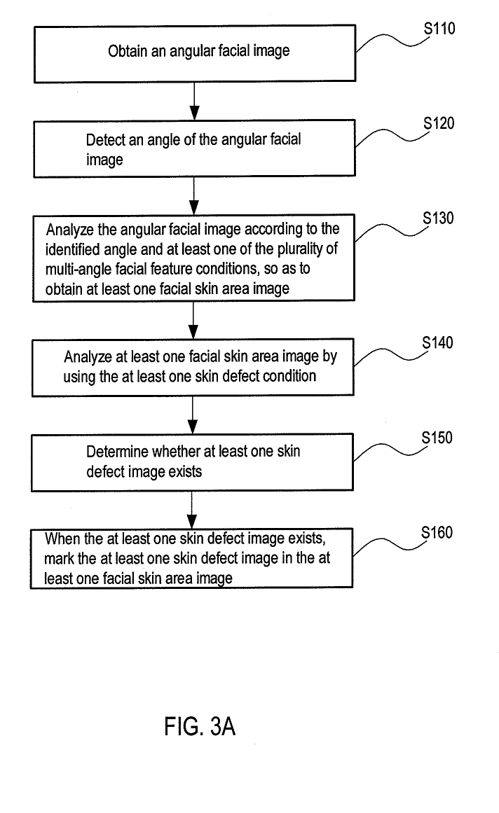

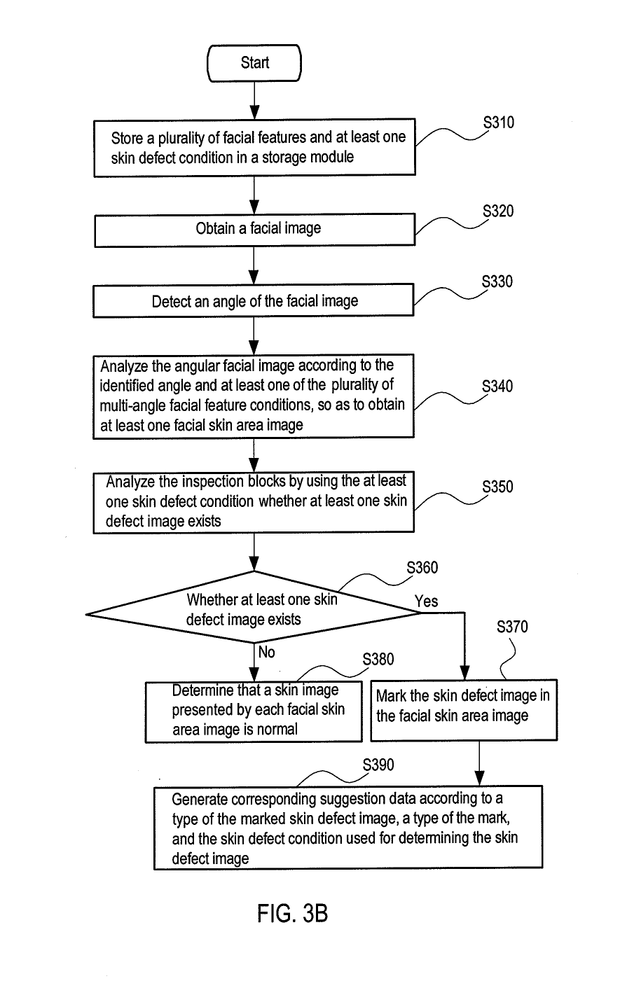

FIG. 3A is a flow chart of a facial skin defect resolution method according to an embodiment of the present invention. Please refer to FIG. 1, FIG. 2, and FIG. 4 to FIG. 6B at the same time and the above illustration for ease of understanding. The method is applicable to an electronic apparatus, and a storage module included in the electronic apparatus stores a plurality of multi-angle facial feature conditions and at least one skin defect condition. In this embodiment, the electronic apparatus is illustrated by, but not limited to, a host 200. The process of the facial skin defect resolution method is illustrated as follows.

In Step S110, an angular facial image is obtained. For example, the angular facial image can be obtained by shooting with an image acquisition module, or transferred from a remote computer or electronic device

In Step S120, an angle of the angular facial image is detected. For example, the angular facial image is detected with the electronic apparatus, and the angle can be a horizontal deflection angle and/or vertical deflection angle of the face relative to the photographic lens.

In Step S130, the angular facial image is analyzed according to the identified angle and at least one of the plurality of multi-angle facial feature conditions, so as to obtain at least one facial skin area image. For example, through the electronic apparatus, the face range in the angular facial image 400 is found by using the conventional face detection technology, and images irrelevant to the face of the user are removed, and only an image of the face range is kept.

In Step S140, at least one facial skin area image is analyzed by using the at least one skin defect condition. For example, the electronic apparatus performs analysis, and the skin defect condition includes at least one of a wrinkle analysis condition, a spot analysis condition, and an acne scar analysis condition.

In Step S150, it is determined whether at least one skin defect image exists. For example, during wrinkle analysis, the electronic apparatus analyzes each pixel of each facial skin area image, and determines whether a plurality of dark pixels exists and the dark pixel form at least one continuous line. During spot analysis, the electronic apparatus analyzes each pixel of each facial skin area image, and determines whether a plurality of dark pixels exists and the dark pixels form at least one dark block.

In Step S160, when the at least one skin defect image exists, the at least one skin defect image in the at least one facial skin area image is marked. For example, the display module 300 displays the detected wrinkle furrow by a simulated line, or marks a spot by using a pattern conforming to the spot shape.

Referring to FIG. 3B, FIG. 3B is a flow chart of a facial skin defect resolution method according to another embodiment of the present invention. Please refer to FIG. 1, FIG. 2, and FIG. 4 to FIG. 6B at the same time and the above illustration for ease of understanding. The steps with the same contents are labeled by the same numbers and will not be illustrated in detail again. The method is also applicable to an electronic apparatus, and the process of the method is illustrated as follows.

In Step S310, a plurality of multi-angle facial feature conditions and at least one skin defect condition are stored in a storage module of the electronic apparatus.

In Step S320, an angular facial image is obtained.

In Step S330, an angle of the angular facial image is detected.

In Step S340, the angular facial image is analyzed according to the identified angle and at least one of the plurality of multi-angle facial feature conditions, so as to obtain at least one facial skin area image, and accordingly the at least one facial skin area image is divided into a plurality of inspection blocks. For example, the patterns of multiple angles and multiple parts of the face are used as a plurality of multi-angle facial feature conditions, and the facial skin area image is compared to find whether a pattern conforming to the facial feature condition exists, the facial skin area image is then divided into a plurality of inspection blocks according to the patterns and positions found therein, such as the forehead block 410, the right canthus block 420, the right eye block 425, the nose bridge block 430, the left canthus block 440, the left eye block 445, the right cheekbone block 450, the nose tip block 460, the lip block 465, the left cheekbone block 470, the right cheek block 480, and the left cheek block 490.

In Step S350, the inspection blocks are analyzed by using the at least one skin defect condition. For example, the electronic apparatus performs analysis, and the skin defect condition includes at least one of the wrinkle analysis condition, the spot analysis condition, and the acne scar analysis condition.

In Step S360, it is determined whether at least one skin defect image exists.

In Step S370, if the determination result is yes, that is, the at least one skin defect image exists, the at least one skin defect image in the at least one facial skin area image is marked.

In Step S380, when the determination result is no, that is, the at least one skin defect image does not exist, it is determined that a skin image presented by each facial skin area image is normal.

In Step S390, corresponding suggestion data is generated according to the marked skin defect image, a type of the skin defect image, a type of the mark, and the skin defect condition used for determining the skin defect image.

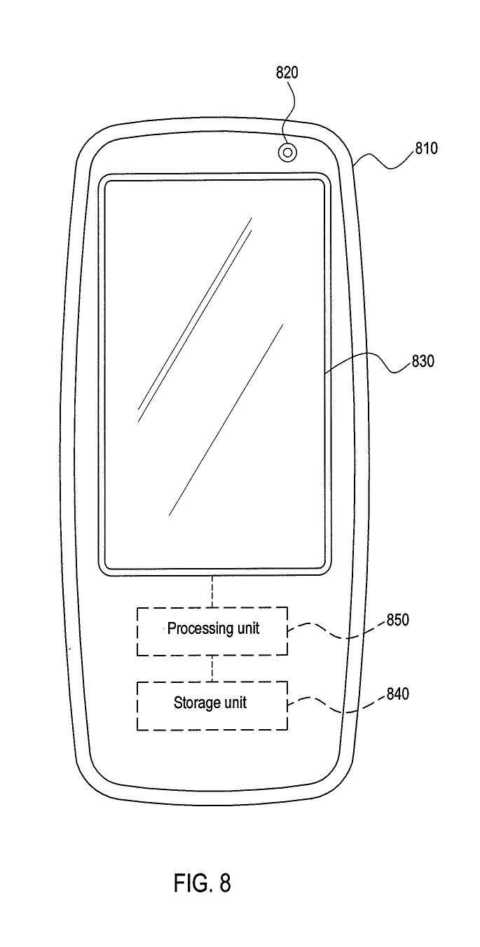

FIG. 8 is a schematic view of a device for facial defect analysis using an angular facial image according to an embodiment of the present invention, which includes: a case 810; an image capturing unit 820, disposed outside the case 810, and used for shooting a face of a user to form an angular facial image; a display unit 830, disposed outside the case 810; a storage unit 840, disposed inside the case 810, electrically coupled to the image capturing unit 820, and used for storing the angular facial image, at least one skin defect condition, and at least one of a plurality of multi-angle facial feature conditions; and a processing unit 850, disposed inside the case 810, electrically coupled to the image capturing unit 820, the storage unit 840, and the display unit 830, and used for analyzing the angular facial image according to the facial feature conditions, so as to obtain at least one facial skin area image, determining whether at least one skin defect image exists in the at least one facial skin area image by using at least one skin defect condition, when the at least one skin defect image exists, marking the at least one skin defect image in the at least one facial skin area image, and displaying the angular facial image and the mark on the display unit 830.

In some embodiments, the device for facial defect analysis using an angular facial image can be specifically implemented by a portable device such as a mobile phone, a PDA, a tablet computer, and a notebook computer. The relevant technical contents are as discussed above, which are no longer described here.

To sum up, the above descriptions are merely implementations or embodiments for presenting the technical means adapted to solve the problem in the present invention, but not intended to limit the scope of the invention. That is, any equivalent modification and variation made in conformity to the content of the claims of the present invention or according to the scope of the present invention shall fall within the scope of the invention.

What is claimed is:

1. A method for facial defect analysis using an angular facial image, applicable to an electronic apparatus, wherein the electronic apparatus at least comprises a storage module for storing a plurality of multi-angle facial feature conditions and at least one skin defect condition, the method comprising:
obtaining an angular facial image;
detecting an angle of the angular facial image;
analyzing the angular facial image according to the identified angle and at least one of the plurality of multi-angle facial feature conditions, so as to obtain at least one facial skin area image;
analyzing the at least one facial skin area image by using the at least one skin defect condition;
determining whether at least one skin defect image exists; and
when the at least one skin defect image exists, marking the at least one skin defect image in the at least one facial skin area image.

2. The method according to claim 1, further comprising:
extracting a face of a user to form the angular facial image by an image acquisition module, wherein the image acquisition module is electrically coupled to the storage module, so as to transfer the angular facial image to the storage module for storage.

3. The method according to claim 1, further comprising:
dividing each facial skin area image into a plurality of inspection blocks respectively according to the identified angle.

4. The method according to claim 3, wherein the inspection blocks are at least one of a forehead block, a right canthus block, a nose bridge block, a left canthus block, a right cheekbone block, a nose tip block, a left cheekbone block, a right cheek block, and a left cheek block.

5. The method according to claim 1, wherein the skin defect condition comprises one of a wrinkle analysis condition, a spot analysis condition, and an acne scar analysis condition.

6. The method according to claim 5, wherein the acne scar analysis condition is generated by introducing a plurality of acne scar pattern samples into a neural network so as to perform sample determination training.

7. The method according to claim 1, wherein after the step of detecting the angle of the angular facial image, the method further comprises dividing the angular facial image into a plurality of inspection blocks according to the identified angle.

8. The method according to claim 1, wherein the apparatus further comprises a display module for displaying the angular facial image and the mark.

9. The method according to claim 1, wherein the storage module is further used for storing at least one suggestion data corresponding to the at least one skin defect condition, and the method further comprises:
generating the corresponding suggestion data according to the marked skin defect image and the skin defect condition used for determining the skin defect image.

10. A system for facial defect analysis using an angular facial image, comprising:
a storage module, used for storing at least one angular facial image, at least one skin defect condition, and at least one of a plurality of multi-angle facial feature conditions;
an image angle detection module, electrically coupled to the storage module, and used for detecting an angle of the angular facial image;
a feature definition module, electrically coupled to the storage module and the image angle detection module, and used for analyzing the angular facial image according to the facial feature conditions, so as to obtain at least one facial skin area image; and
a skin analysis module, electrically coupled to the storage module and the feature definition module, and used for determining whether at least one skin defect image exists in the at least one facial skin area image by using the at least one skin defect condition, and if yes, marking the at least one skin defect image in the at least one facial skin area image.

11. The system according to claim 10, further comprising an image acquisition module for extracting a face of a user to form the angular facial image, and the image acquisition module is electrically coupled to the storage module, so as to transfer the angular facial image to the storage module for storage.

12. The system according to claim 10, wherein the feature definition module further comprises dividing each facial skin area image into a plurality of inspection blocks respectively according to the identified angle.

13. The system according to claim 10, wherein the inspection blocks are at least one of a forehead block, a right canthus block, a nose bridge block, a left canthus block, a right cheekbone block, a nose tip block, a left cheekbone block, a right cheek block, and a left cheek block, and the feature definition module finds at least one inspection block in the angular facial image different from the multi-angle facial feature conditions.

14. The system according to claim 10, wherein the skin defect condition comprises one of a wrinkle analysis condition, a spot analysis condition, and an acne scar analysis condition.

15. The system according to claim 14, further comprising an acne scar determination rule, and the acne scar determination rule is generated by introducing a plurality of acne scar pattern samples into a neural network so as to perform sample determination training.

16. The system according to claim 10, further comprising a display module for displaying the angular facial image and the mark.

17. The system according to claim 10, wherein the feature definition module is further used for dividing the angular facial image into a plurality of inspection blocks according to the identified angle after the detection of the angle of the angular facial image.

18. The system according to claim 10, wherein the storage module is further used for storing at least one suggestion data corresponding to the at least one skin defect condition, and the system further comprises:
a suggestion module, used for generating the corresponding suggestion data according to the marked skin defect image and the skin defect condition used for determining the skin defect image.

19. A device for facial defect analysis using an angular facial image, comprising:
a case;
an image capturing unit, disposed outside the case, and used for shooting a face of a user to form an angular facial image;
a display unit, disposed outside the case;
a storage unit, disposed inside the case, electrically coupled to the image capturing unit, and used for storing the angular facial image, at least one skin defect condition, and at least one of a plurality of multi-angle facial feature conditions; and
a processing unit, disposed inside the case, electrically coupled to the image capturing unit, the storage unit, and the display unit, and used for analyzing the angular facial image according to the facial feature conditions, so as to obtain at least one facial skin area image, determining whether at least one skin defect image exists in the at least one facial skin area image by using the at least one skin defect condition, when the at least one skin defect image exists, marking the at least one skin defect image in the at least one facial skin area image, and displaying the angular facial image and the mark on the display unit.

20. A computer program product for facial defect analysis using an angular facial image, for being read by an electronic apparatus to perform a facial skin defect resolution method, wherein the electronic apparatus at least comprises a storage module for storing a plurality of multi-angle facial feature conditions and at least one skin defect condition, and the method comprises:
obtaining an angular facial image;
detecting an angle of the angular facial image;
analyzing the angular facial image according to the identified angle and at least one of the plurality of multi-angle facial feature conditions, so as to obtain at least one facial skin area image;
analyzing the at least one facial skin area image by using the at least one skin defect condition;
determining whether at least one skin defect image exists; and
when the at least one skin defect image exists, marking the at least one skin defect image in the at least one facial skin area image.
